(19) United States
(12) Patent Application Publication
(10) Pub. No.: US 2016/0301354 A1
(43) Pub. Date: Oct. 13, 2016

(54) PORTABLE SOLAR PANEL POWER SOURCE

(71) Applicant: Hyde Park Partners, Inc., Charlotte, NC (US)

(72) Inventors: David Scott Draffin, II, Tega Cay, SC (US); William Pape Wood, Charlotte, NC (US); Melvin Joseph Radford, Charlotte, NC (US)

(21) Appl. No.: 15/091,931

(22) Filed: Apr. 6, 2016

Related U.S. Application Data
(60) Provisional application No. 62/145,017, filed on Apr. 9, 2015.

(51) Int. Cl. H02S 10/40; H02S 40/38

(52) U.S. Cl. CPC H02S 10/40; H02S 40/38

(57) ABSTRACT

A portable solar power source assembly including a solar panel and portable power source having a housing with a battery positioned within the housing, wherein the portable power source is operatively connected to the solar panel for recharging the battery and the housing includes at least one electrical connection for charging an electronic device with power from the battery.

### CROSS-REFERENCE TO RELATED APPLICATION

This U.S. Non-Provisional Patent Application claims priority from U.S. Provisional Patent Application No. 62/145,017 filed on Apr. 9, 2015, which is incorporated herein by reference in its entirety.

### TECHNICAL FIELD AND BACKGROUND OF THE INVENTION

The present invention relates generally to the field of portable power supplies, and more particularly, to a compact, self-contained solar panel power source including a housing concealing a rechargeable battery, associated electronics, cabling, a solar panel for charging the battery as needed, light emitting diodes (LEDs) for providing a light source as needed, and a plurality of electrical inputs and outputs accessible through a side of the housing for connecting devices to be charged.

Portable power supplies are used to provide power in remote locations without grid access. The most common type of portable power supply is a gas generator, which may be bulky, cumbersome and difficult to transport. Gas generators further burn fossil fuels, which are expensive, non-renewable, require transport and contribute to increased atmospheric carbon dioxide levels when burned. Thus, as an alternative to conventional gas generators, what is needed is an easily transportable, compact, self-contained power supply that runs off of a renewable energy source, particularly in low power applications for charging portable electronic devices (e.g., mobile phones and computers) and powering light sources as necessary.

### BRIEF SUMMARY OF THE INVENTION

Therefore, the disclosed devices and methods provide an easily transportable, compact, self-contained power supply that runs off of a renewable energy source, particularly in low power applications for charging portable electronic devices (e.g., mobile phones and computers) and powering light sources as necessary. The disclosed portable power sources and portable power source assemblies provide advantageous portability allowing one to easily transport the power source and/or power source assembly in a suitcase, bookbag, briefcase, or other small transport storage compartment and further allowing one to easily re-charge peripheral devices such as smartphones, laptops, tablets, etc. in remote areas and third world countries using solar power.

Specifically disclosed herein are portable solar power source assemblies including a solar panel and a portable power source , the portable power source having a housing with a battery positioned in the housing, wherein the portable power source is operatively connected to the solar panel for recharging the battery; the housing includes an electrical output for charging an electronic device with power from the battery; and the battery has a battery capacity ranging from 5,000 mAh to 10,000 mAh.

In certain aspects, the housing of the portable power source comprises a top wall, bottom wall, side walls, and a front wall adapted to snap together with an interference fit to form the housing defining an enclosed cavity with the battery secured therein.

In certain aspects, at least one outlet for re-charging a peripheral device is positioned on the front wall, and wherein at least one outlet for powering a light source and one input for operatively connecting the solar panel to the battery that are each positioned on the bottom wall, the at least one outlet for powering an illumination source and one inlet for operatively connecting the solar panel to the battery are each inwardly recessed and adjacent to a bottom peripheral edge of the front wall.

In certain aspects, the front wall includes a top peripheral edge, a bottom peripheral edge opposing the top peripheral edge, and two opposing side peripheral edges. Each of the peripheral edges form a groove adapted to channel fluids away from the housing to prevent and/or reduce fluid entry into any outlet or input positioned on the front wall and bottom wall of the portable power source.

In certain aspects, the battery is operatively linked to a circuit board including a microcontroller configured to monitor electrical output, recognize parasitic draw from the illumination source (light source), and extend overall battery life by preventing and/or reducing parasitic draw from the illumination source (light source).

In certain aspects, the battery voltage of the battery ranges from 8.9V to 12.7V.

In certain aspects, the battery capacity of the battery ranges from 7,000 mAh to 8,500 mAh.

In certain aspects, the battery is a lithium ion battery.

In certain aspects, the lithium ion battery is a 11.1 volt, direct current lithium ion battery having 7,800 mAh battery capacity.

In certain aspects, the portable power source assembly further includes at least one light emitting diode as the illumination source configured for electrical connection to the battery of the power source. The number of light emitting diodes can vary, and preferably range from between 3 to 8 and more preferably from 4 to 6. These light emitting diodes illuminate an area around thereby providing clear visibility around the portable power source assembly when recharging and/or powering an electronic device such as, for example, a smartphone, a laptop computer, a tablet computer, a PDA, or any other small, personal electronic device.

In certain aspects, the portable power source assembly may be prepacked as a kit.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 depicts the portable solar power source operatively connected to a solar panel and charging an electronic device according to an embodiment of the invention;

FIG. 2 is a magnified view of the portable solar power source;

FIG. 3a is a schematic electrical circuit diagram of the portable solar power source according one embodiment of the invention, and FIG. 3b depicts an exemplary circuit board that is placed within the housing of the portable solar power source for charging electronic devices;

FIG. 4 depicts LED lights that may be used as a lighting source during operation of the portable solar power source;

FIG. 5 depicts packaging in which the portable solar power source may be packaged for shipping and handling purposes; and

FIG. 6 depicts a perspective view of the portable power source.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

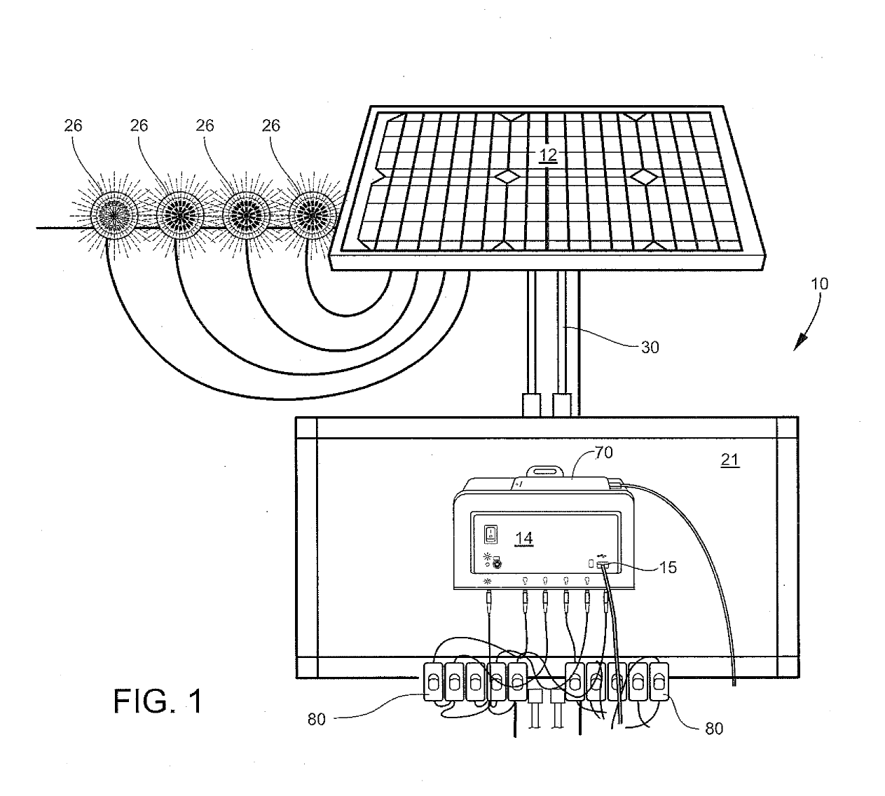

FIGS. 1-4 and 6 disclose a portable solar power source assembly 10 including a solar panel 12 and portable power source 14 that includes a housing with a battery 40 positioned therein. As shown in FIG. 1, when in use, the portable power source 14 is operatively connected to the solar panel 12 for recharging the battery 40; and the housing includes at least one electrical connection 15 for charging an electronic device 70 (e.g., a smart phone or a computer) and powering LED light(s) 26 with power from the battery. The solar power source assembly 10 optionally further includes frame 30 on which solar panel 12 and portable power source 14 may be removably attached thereto.

With specific reference to portable power source 14, portable power source includes a housing comprising a plurality of side walls 16-19, a front face 20, and backing defining a cavity in which battery 40 is securely positioned therein. The plurality of side walls 16-19 including front face 20 are designed to snap fit together and attach onto backing 21 with a slight interference fit. Housing is preferably made from a durable, rigid material that may include a metal or metal alloy, a thermoplastic resin, or a combination thereof so that portable power source 14 may be used outdoors for extended periods. In certain aspects, a flame retardant, UV stabilizer, or a combination thereof is further incorporated within the durable, rigid material to further enhance durability and weather resistance characteristics of the portable power source 14. In preferred aspects, the housing is made from an injection molded thermoplastic resin.

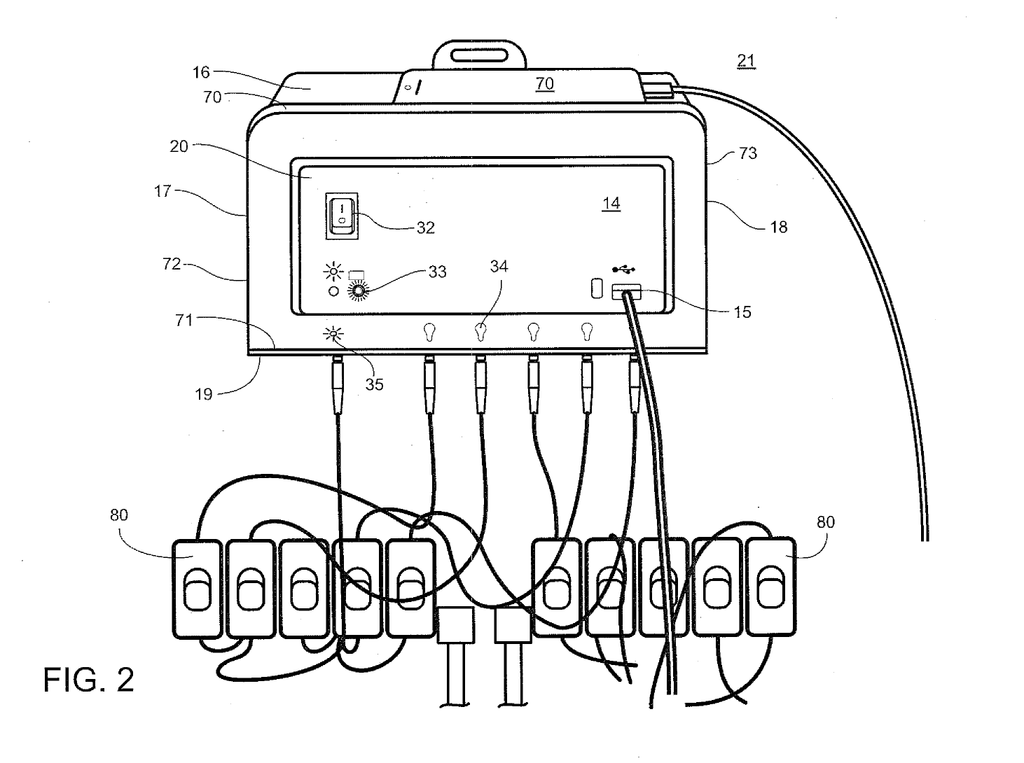

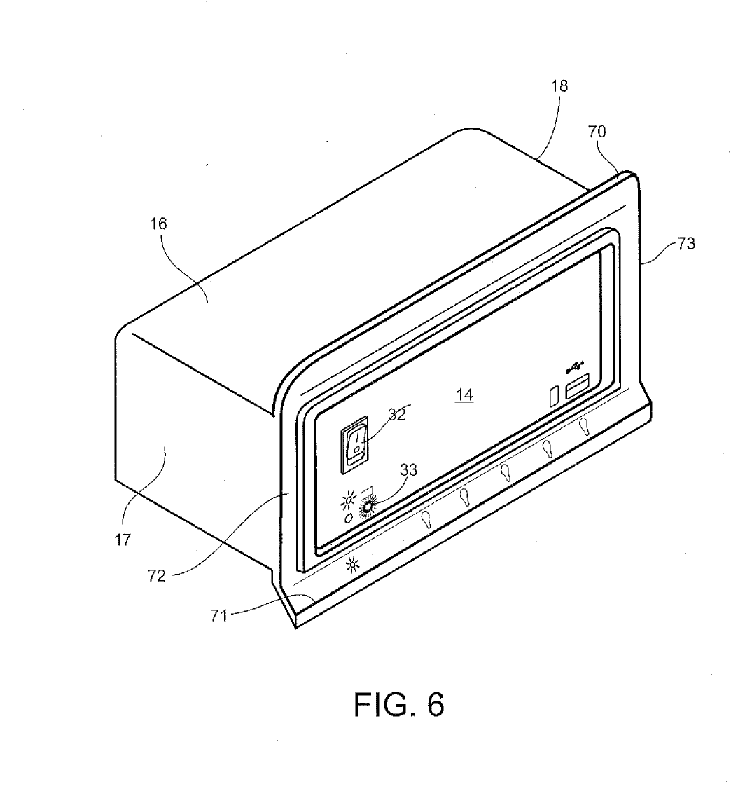

Front face 20 of housing includes an ON/OFF switch 32, indicia and a corresponding light indicating battery level status 33 (e.g., an LED status light indicating battery charge status), indicia and corresponding electrical outputs 34 for powering LED light(s) 26, indicia and corresponding electrical connection 15 (e.g., an USB charging port) for charging electronic device 70, and indicia and corresponding electrical input 35 for operatively connecting solar panel 12 to power source 14. As shown, for example, in FIGS. 2 and 6 peripheral edges 70, 71, 72, 73 of front face 20 preferably have subtle curves and indentations (e.g., arcuate grooves) to provide both an aesthetically appealing look as well as water shedding capabilities. Side wall 16 preferably has sufficient width to act as a shelf for storing electronic device 70 while charging, and side wall 19 preferably has electrical outputs and inputs (LED light output ports and openings for the solar input port) corresponding with, for example, indicia 34, 35 respectively for operative connection to LED light(s) 26 and solar panel 12. Retaining members 80 may be optionally attached to backing 21 and are configured to hold and organize cords extending from, for example the LED light(s) to an electrical output.

Solar panel 12 may be either a flexible or inflexible, glass or non-glass solar panel having a plurality of solar cells electrically interconnected through associated wiring. Solar panel 12 includes a single electrical connector that plugs into electrical input 35 for electrically connecting the solar panel to and charging the rechargeable battery 40. The number, area, and types of solar cells can be varied depending on the desired output of the portable power source 14. For example, the portable power source 14 may have rated outputs not exceeding 50 Watts, preferably not exceeding 40 Watts, more preferably not exceeding 30 Watts, and most preferably not exceeding 20 Watts. In this aspect, solar panel 12 may have a nominal 12V direct current (DC) output for charging the battery that ultimately charges electronic device(s) 70 and powers LED light(s) 26. In certain aspects, solar panel 12 comes equipped with a 5 meter cable. One end of the cable is terminated in a junction box of the panel and the other end is terminated in a 2.5 millimeter DC jack. Solar panel 12 is preferably ruggedly designed with the ability to withstand high wind pressure, hail, and snow, and further configured to charge or power up to 2, 4, and 6 devices 70 at one time, respectively.

With regard to the internal structure of portable power source 14, battery 40 may be securely positioned in the cavity of the housing to prevent shifting. Battery 40 may utilize a lithium ion battery having variable mAh capacities. For example, battery capacity may range from 5,000 mAh to 10,000 mAh, from 6,000 mAh to 9,000 mAh, from 7,000 mAh to 8,500 mAh for rated outputs not exceeding 50 Watts, preferably not exceeding 40 Watts, more preferably not exceeding 30 Watts, and most preferably not exceeding 20 Watts. In certain aspects, battery 40 is an 11.1VDC Lithium-ion type (LiCoO₂) with a rated capacity of 7800 mAh. Due to the Lithium Ion chemistry, battery 40 may be configured to run down to 20% depth of discharge without having any negative effects on battery life or performance, and may last for more than 1000 cycles. Battery 40 is preferably configured as a 3 series, 3 parallel (3S3P) pack using a total of (9) 18650 (2600 mAh) cells. Battery voltage may range from 8.9V to 12.7V. Battery 40 may be further protected via a battery protection circuit board that is integrally mounted and wired into the pack. The protection circuit provides protection from over charging and over discharging as well as ensures that each bank of 3 cells in series is charged at the same rate. Battery 40 can also be recharged through a standard wall outlet when main power is available.

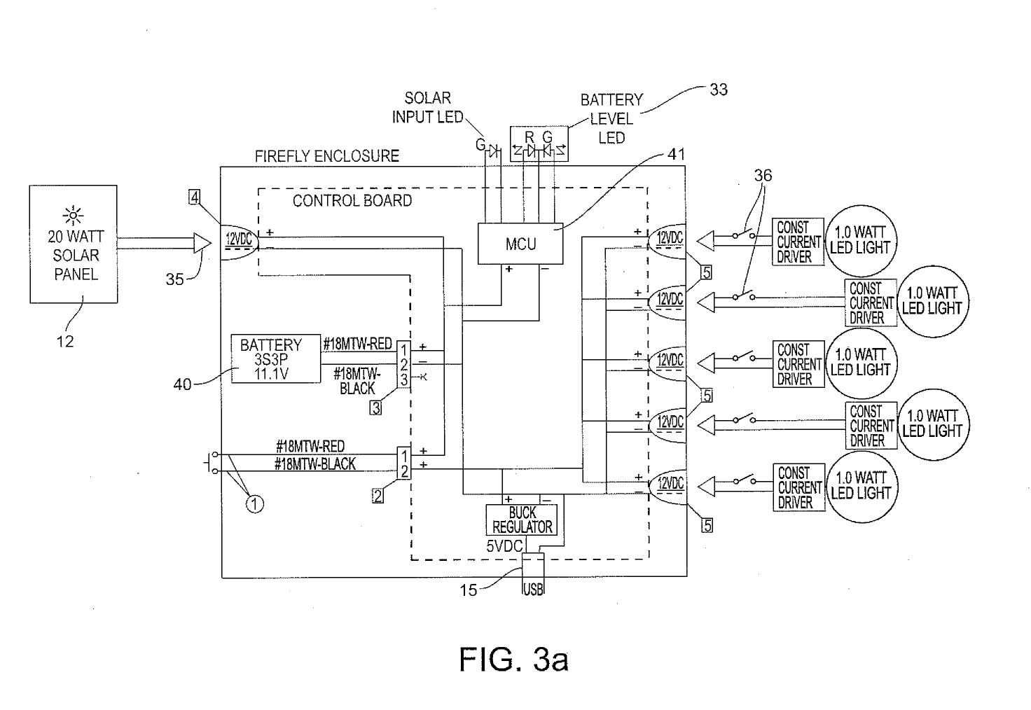

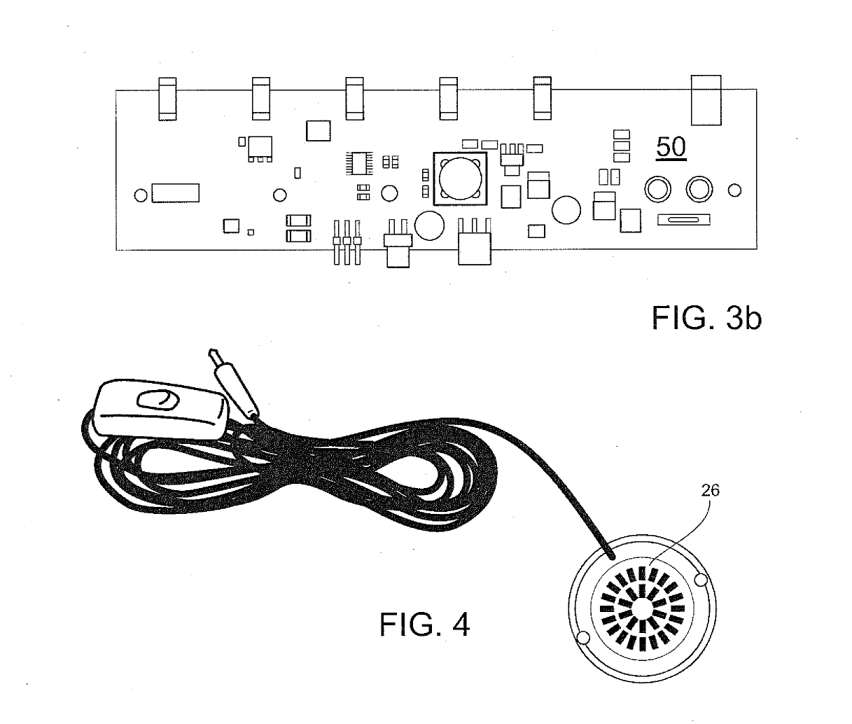

FIGS. 3a, 3b, and 4 respectively show a schematic wiring diagram and circuit board 50 of the portable power source 14. The schematic wiring diagram depicts an exemplary circuit operatively connected to battery 40, electrical connection 15, electrical input 35, and electrical output(s) 36. In certain aspects, the circuit board depicted in FIG. 3b is a printed circuit board (PCB) that provides an integrated charge circuit for battery 40 along with all necessary circuits and logic to distribute power to outputs. The circuit board 50 may be a Freescale Semiconductor MC9S08SH8 microcontroller that includes a custom program developed to harness the energy from the solar panel by the most efficient means possible, e.g. Maximum Power Point Tracking (MPPT), to charge the battery 40, electronic device 70, and power LED lights 26.

The portable power source 14 may constantly utilize whatever solar power is available to maintain the battery 40 at a full charged state. In addition to maintaining the charge of battery 40, microcontroller 41 is configured to monitor, report, and extend the overall battery life. In certain aspects, the circuit board may be configured to alert the operator to battery status and solar panel functionality through a tri-color LED (battery) and a single green LED (Solar) mounted on front face 20. If the LED lights 26 are inadvertently left on and/or the system reaches a low voltage set point, microcontroller 41 has built in logic to internally disengage the outputs 34 until the master power switch is cycled. This will afford battery 40 the opportunity to recharge without the parasitic draw of the LED light(s) 26. Alternatively, if portable power source 14 is allowed to run to a low voltage and left without the ability to recharge itself, microcontroller 41 is able to terminate its outputs 34 and put itself into a “sleep” mode resulting in very little power draw, thus extending shelf life and preventing battery 40 from being damaged. In certain aspects, portable power source 14 has a runtime ranging from 12 to 24 hours, 15 hours to 20 hours, 16 hours to 18 hours for charging electronic device(s) 70 and powering LED lights 26, and a charge time of 1 day or less during good solar conditions.

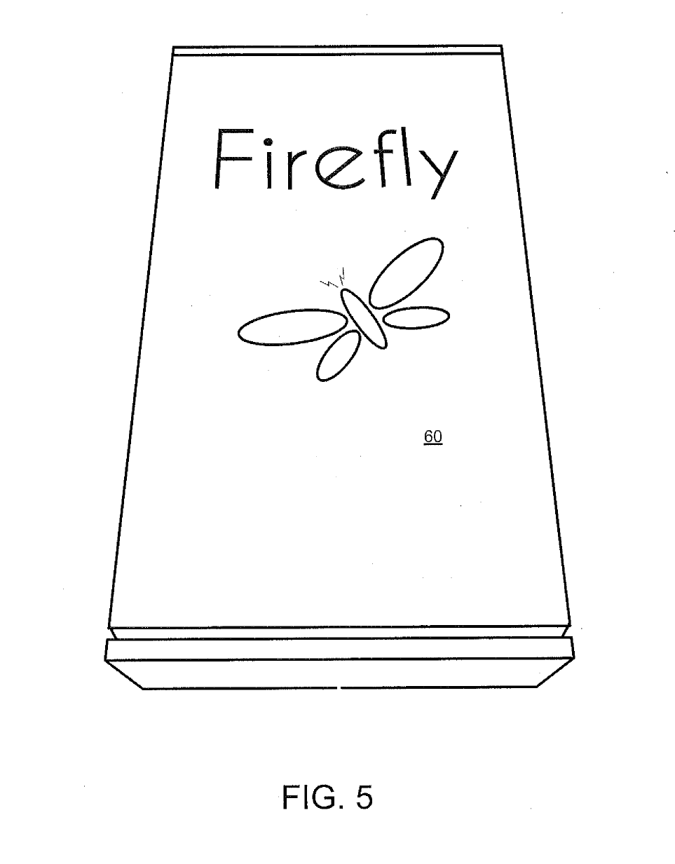

In certain aspects, the portable solar power source assembly 10, and more particularly, the portable power source 14 may be packaged and sold retail. For example, FIG. 5 depicts packaging 60 in which the portable solar power source assembly 10 or portable power source 14 may be packaged for shipping and handling purposes.

Applications that may benefit from portable solar power source assembly 10 described herein include, but are not limited to, off-the grid applications, construction, forestry, emergency response, tailgating, festivals, etc. When not in use, the portable solar power source assembly described herein may be quickly disassembled and stored for later use.

The foregoing description provides embodiments of the invention by way of example only. It is envisioned that other embodiments may perform similar functions and/or achieve similar results. Any and all such equivalent embodiments and examples are within the scope of the present invention and are intended to be covered by the appended claims.

What is claimed is:

1. A portable solar power source assembly comprising:
(a) a solar panel; and
(b) portable power source, the portable power source having a housing with a battery positioned in the housing, wherein the portable power source is operatively connected to the solar panel for recharging the battery;
(c) an electrical output positioned in the housing for charging an electronic device with power from the battery; and
(d) the battery has a battery capacity ranging from 5,000 mAh to 10,000 mAh.

2. The portable solar power source assembly of claim 1, wherein the housing of the portable power source comprises a top wall, bottom wall, side walls, and a front wall adapted to snap together with an interference fit to form the housing defining an enclosed cavity with the battery secured therein.

3. The portable solar power source assembly of claim 2, wherein at least one outlet for re-charging a peripheral device is positioned on the front wall, and
wherein at least one outlet for powering a light source and one input for operatively connecting the solar panel to the battery that are each positioned on the bottom wall, the at least one outlet for powering an illumination source and one inlet for operatively connecting the solar panel to the battery are each inwardly recessed and adjacent to a bottom peripheral edge of the front wall.

4. The portable solar power source assembly of claim 3, wherein the front wall comprises a top peripheral edge, the bottom peripheral edge opposing the top peripheral edge, and two opposing side peripheral edges, wherein each peripheral edge forms a groove adapted to channel fluids away from the housing to prevent and/or reduce fluid entry into any outlet or input positioned on the front wall and bottom wall of the portable power source.

5. The portable solar power source assembly of claim 4, wherein the battery is operatively linked to a circuit board including a microcontroller that is configured to monitor electrical output, recognize parasitic draw from the illumination source, and extend overall battery life by preventing and/or reducing parasitic draw from the illumination source.

6. The portable solar power source assembly of claim 5, wherein battery voltage ranges from 8.9V to 12.7V.

7. The portable power source assembly of claim 6, wherein the battery capacity of the battery ranges from 7,000 mAh to 8,500 mAh.

8. The portable power source assembly of claim 7, wherein the battery is a lithium ion battery.

9. The portable power source assembly of claim 8, wherein the lithium ion battery is a 11.1 volt, direct current lithium ion battery having 7,800 mAh battery capacity.

10. The portable power source assembly of claim 9, further comprising at least one light emitting diode as the illumination source configured for electrical connection to the battery of the power source and for illumination of an area around the assembly to allow an assembly user to identify the at least one outlet on the front face for re-charging the peripheral device.

11. A portable solar power source comprising
(a) a housing;
(b) a battery positioned within the housing and configured to be recharged by a solar panel; and
(c) at least one electrical connection for charging an electronic device with power from the battery.

12. The portable solar power source of claim 11, further comprising:
(d) a charge controller configured to utilize maximum power point tracking and charge the battery, wherein the battery is a lithium ion battery.

13. The portable solar power source of claim 12, wherein the housing of the portable power source comprises a top wall, bottom wall, side walls, and a front wall adapted to snap together with an interference fit to form the housing defining a cavity and enclosure with the battery secured therein.

14. The portable solar power source of claim 13, wherein at least one outlet for re-charging a peripheral device is positioned on the front wall, and further wherein at least one outlet for powering an illumination source and one input for operatively connecting the solar panel to the battery that are positioned on the bottom wall, the at least one outlet for powering an illumination source and one input for operatively connecting the solar panel to the battery are each inwardly recessed relative to a bottom peripheral edge of the front wall.

15. The portable solar power source of claim 14, wherein the front wall comprises a top peripheral edge, the bottom peripheral edge opposing the top peripheral edge, and two opposing side peripheral edges, wherein each peripheral edge forms a groove adapted to channel fluids away from the housing of the portable power source to prevent and/or reduce fluid entry into any outlet or input positioned on the front wall and bottom wall of the portable power source.

16. The portable solar power source of claim 15, wherein the battery is operatively linked to a circuit board including a microcontroller configured to monitor electrical output, recognize parasitic draw, and extend overall battery life by preventing and/or reducing parasitic draw.

17. The portable solar power source of claim 16, wherein the portable power source is compact and adapted for storing in at least one of a suitcase, a book bag, a briefcase, or any combination thereof.

18. The portable power source assembly of claim 18, wherein the lithium ion battery is a 11.1 volt, direct current lithium ion battery having 7,800 mAh battery capacity.
